(19) United States
(12) Patent Application Publication
(10) Pub. No.: US 2026/0365877 A1
(43) Pub. Date: Nov. 19, 2026

(54) RESIN COMPOSITION AND ARTICLE MADE THEREFROM

(71) Applicant: Elite Electronic Material (KunShan) Co., Ltd., Kunshan City (CN)

(72) Inventors: Jinke WU, Kunshan City (CN); Xingxing YAO, Kunshan City (CN); Rongtao WANG, Kunshan City (CN); Yiqiang GE, Kunshan City (CN)

(21) Appl. No.: 19/291,988

(22) Filed: Aug. 6, 2025

(30) Foreign Application Priority Data
Apr. 30, 2025 (CN) 202510570359.0

(51) Int. Cl. C09D 179/08; B32B 15/08; C09D 4/06

(52) U.S. Cl. CPC C09D 179/085; B32B 15/08; C09D 4/06

(57) ABSTRACT

The present invention relates to a resin composition, including
(A) 100 parts by weight of maleimide represented by Formula (1),
(B) 10 to 30 parts by weight of a (meth)acrylate monomer having a triazine ring and/or an oligomer thereof, and
(C) 5 to 15 parts by weight of an allylphenolic compound,

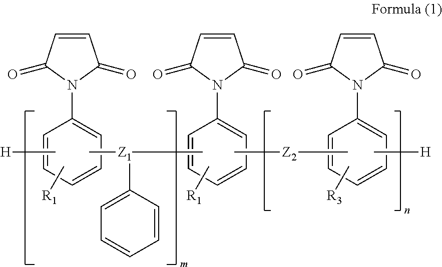

In Formula (1), R₁ and R₃ each represent a C2-C5 alkyl group, R₂ represents a hydrogen atom or a C1-C5 alkyl group, and Z₁ and Z₂ each represent a C1-C5 alkylene group.

In addition, the present invention also relates to an article made from the aforementioned resin composition, including a prepreg, a resin film, a metallic clad laminate or a printed circuit board, and the article achieves improvements in at least one of the properties such as resin agglomeration, in-plane resin flow length, resin filling property, resin flow decay rate, storage modulus decay rate, and peel strength.

### CROSS-REFERENCE TO RELATED APPLICATION

The present application claims priority to Chinese Patent Application No. 202510570359.0 filed with China National Intellectual Property Administration on Apr. 30, 2025, the entire contents of which are incorporated herein by reference.

### TECHNICAL FIELD

The present invention relates to a resin composition, and more particularly to a resin composition comprising maleimide, and an article made from the resin composition, such as a prepreg, a resin film, a metallic clad laminate and a printed circuit board.

### BACKGROUND

Printed circuit board (PCB), as a basic electronic component, has been applied in various fields such as mobile phones, computers, mobile communications, data centers, automobiles, industrial control, medical care, aerospace etc., and the technical level and reliability thereof have a direct impact on the performance and stability of electronic devices. Advanced PCB packaging technology currently faces issues in aspects such as process capability, signal integrity, flame retardancy, heat dissipation, and stress, thereby presenting higher demands for the performance of metallic clad laminates as base materials.

In current prepregs, resin films, metallic clad laminates, and printed circuit board articles, maleimide resin has become an important matrix resin due to its excellent properties, such as a relatively high glass transition temperature and a relatively low coefficient of thermal expansion. However, the current maleimide resin needs to be further improved in aspects such as resin agglomeration, in-plane resin flow length, and resin filling property, and fails to satisfy more than one of the properties such as lower resin flow decay rate, lower storage modulus decay rate, and higher peel strength.

In view of the above, there is still a need in this field for a maleimide-based resin composition having improved resin agglomeration, suitable in-plane resin flow length, and superior resin filling property, while also featuring more than one of the properties such as lower resin flow decay rate, lower storage modulus decay rate, and higher peel strength.

### SUMMARY

One objective of the present invention is to provide a resin composition which, compared with prior arts, achieves improvements in at least one of the properties such as resin agglomeration, in-plane resin flow length, resin filling property, resin flow decay rate, storage modulus decay rate, and peel strength.

To this end, the present invention discloses a resin composition, comprising:
(A) 100 parts by weight of maleimide represented by Formula (1),
(B) 10 to 30 parts by weight of a (meth)acrylate monomer having a triazine ring and/or an oligomer thereof, and
(C) 5 to 15 parts by weight of an allylphenolic compound,

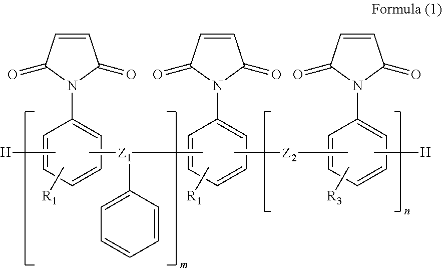

wherein in Formula (1), R₁ and R₃ each independently represent a C2-C5 alkyl group, R₂ represents a hydrogen atom or a C1-C5 alkyl group, m is a value of 1 to 10, n is a value of 1 to 10, and Z₁ and Z₂ each independently represent a C1-C5 alkylene group.

In one embodiment, the aforementioned (meth)acrylate monomer having a triazine ring and/or an oligomer thereof comprises any one or a combination of two or more of an acrylate monomer represented by Formula (A) and/or an oligomer thereof, and an acrylate monomer represented by Formula (B) and/or an oligomer thereof:

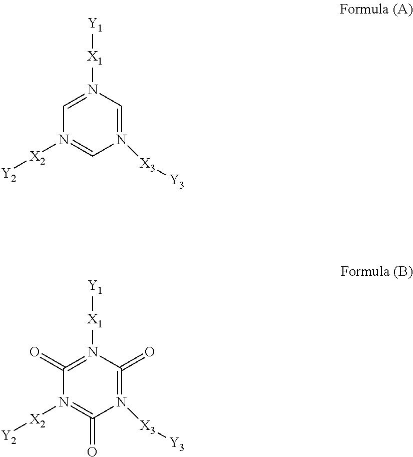

wherein in Formula (A) and Formula (B), X₁ to X₃ each independently represent a C1 to C5 alkylene group, and Y₁ to Y₃ each independently represent an acrylate group or a methacrylate group.

In one embodiment, the aforementioned allylphenolic compound comprises any one or a combination of two or more of allyl bisphenol A, allyl bisphenol F, allyl biphenol, and allyl fluorenol.

In one embodiment, the aforementioned resin composition may further comprise an epoxy resin, with the mass ratio of the epoxy resin to the allylphenolic compound being 1:1 to 1:7, preferably being 1:1 to 1:4.

In one embodiment, the aforementioned epoxy resin comprises any one or a combination of two or more of bisphenol A epoxy resin, bisphenol F epoxy resin, bisphenol S epoxy resin, bisphenol AD epoxy resin, phenol novolac epoxy resin, bisphenol A novolac epoxy resin, bisphenol F novolac epoxy resin, bisphenol S novolac epoxy resin, bisphenol AD novolac epoxy resin, o-cresol novolac epoxy resin, phenol-aralkyl epoxy resin, naphthalene epoxy resin, biphenyl epoxy resin, dicyclopentadiene epoxy resin, benzofuran epoxy resin, isocyanate epoxy resin, and DOPO epoxy resin.

In one embodiment, the aforementioned resin composition may further comprise any one or a combination of two or more of polyolefin, polyester resin, polyphenylene ether resin, silicone resin, benzoxazine resin, phenolic resin, amine curing agent, polyamide, polyimide, styrene maleic anhydride, cyanate ester, and maleimide triazine resin.

In one embodiment, the aforementioned composition may further comprise any one or a combination of two or more of a flame retardant, a curing accelerator, a polymerization inhibitor, an inorganic filler, a solvent, a silane coupling agent, a surfactant, a coloring agent, and a toughening agent.

Another objective of the present invention is to provide an article made from the resin composition, comprising a prepreg, a resin film, a metallic clad laminate or a printed circuit board.

In one embodiment, the aforementioned article has at least one of the following properties:
a deduction for resin agglomeration of ≤5 points, for example, a deduction of 3 to 5 points;
an in-plane resin flow length of 7.0 to 9.0 mm, for example, 7.1 to 9.0 mm;
having no voids and no dendritic patterns after a resin filling property test;
a resin flow decay rate of ≤4.0%, for example, 2.8 to 3.6%;
an storage modulus decay rate as measured and calculated by reference to the method stated in IPC-TM-650 2.4.24.4 of ≤40%, for example, 33 to 39%; and
a peel strength as measured by reference to the method stated in IPC-TM-650 2.4.8 of ≥4.0 lb/in, for example, 4.1 to 4.9 lb/in.

Methods for measuring the aforementioned properties will be described in detail below.

### BRIEF DESCRIPTION OF THE DRAWINGS

The present invention will be described and explained in more detail hereinafter in conjunction with the drawings, in which:

FIG. 1 shows a schematic diagram of resin agglomeration, wherein a resin agglomerate with a size of 25.6 μm is marked;

FIG. 2 shows a schematic diagram of the presence of voids in a resin filling property test, wherein the circled white parts are voids;

FIG. 3 shows a schematic diagram of the presence of dendritic patterns in a resin filling property test, wherein the strips in the middle of dendritic patterns are areas filled with resin; and

FIG. 4 shows a schematic diagram of the absence of voids and dendritic patterns in a resin filling property test.

### DETAILED DESCRIPTION OF EMBODIMENTS

To enable those skilled in the art to clearly and correctly understand the technical content of the present invention, the terms and symbols mentioned in the specification and claims are hereby generally described and defined as follows: Unless otherwise defined or implied in this specification, all terms and symbols (including scientific terms, technical terms, and general symbols, wherein the general symbols include general mathematical symbols, general physical symbols, general chemical symbols, etc.) used in the present invention have the same meanings as those commonly understood by those skilled in the art. It should also be appreciated that, unless expressly defined in this specification, the terms and symbols (such as the terms defined in a general dictionary) should be construed as having meanings consistent with those in the context of relevant fields, and should not be construed in an idealized or overly formalistic meaning.

The “containing an unsaturated carbon-carbon double bond” as described in the present invention refers to “containing an unsaturated C═C double bond group”, such as but not limited to a vinyl group, a vinylbenzyl group, a (meth)acryloyl group, and an allyl group, etc. Among them, the “vinyl group” should be construed as comprising a vinyl group and a vinylene group, and the “(meth)acryloyl group” should be construed as comprising an acryloyl group and a methacryloyl group.

The alkyl group, alkenyl group, alkynyl group and other functional groups and structural units as described in the present invention should be construed to encompass various isomers thereof. For example, the “alkyl group” refers to groups derived from aliphatic hydrocarbons and includes linear, branched or cyclic groups. Further, for example, a propyl group should be construed to encompass n-propyl group and isopropyl. For another example, a triazine ring has three isomers, namely, 1,2,3-triazine, 1,2,4-triazine, and 1,3,5-triazine. The “monomer” and “compound” as described in the present invention should also be construed to encompass various isomers thereof.

In the present invention, “part(s) by weight” should be construed as relative part(s) by weight, which may be any weight unit, such as but not limited to kilo, kilogram, gram, pound and so on.

In the present invention, wt % represents weight (or mass) percentage.

In the present invention, mil is a thickness unit, and 1 mil is about 25.4 microns; ounce is also a thickness unit, and 1 ounce is about 35 microns.

In the present invention, the expression “any one or a combination of two or more” should be construed as “using any one of the listed elements alone” or “using a combination of any two of the listed elements” or “using a combination of three or more of the listed elements”.

In the present invention, the ranges of values represented by “equal to”, “=”, “greater than or equal to”, “≥”, “smaller than or equal to”, “≤”, “to” or “-” should be construed as including the endpoint values, and should be construed to encompass all possible subranges and individual values therein (the types of values including, but not limited to, integers, decimals, and fractions). For example, the ranges of values represented by “equal to 3.0”, “=3.0”, “greater than or equal to 3.0”, “≥3.0”, “smaller than or equal to 3.0”, and “≤3.0” all include the endpoint value “3.0”; the ranges of values represented by “3.0 to 6.0” and “3.0-6.0” both include the endpoint values “3.0” and “6.0”, and should be construed as including but not limited to, the subranges such as “3.0-5.0”, “4.0-6.0”, and “5.0-6.0”, and the individual values such as 3.0, 4.0, 5.0, 5.5, and 6.0.

In the present invention, the ranges of values represented by “greater than”, “>”, “smaller than”, and “<” should be construed as not including the endpoint values. For example, the ranges of values represented by “greater than 3.0”, “>3.0”, “smaller than 3.0”, and “<3.0” should all be construed as not including the endpoint value “3.0”.

In the present invention, the values have a precision which is achieved using the rounding method for significant figures.

In the present invention, a polymer comprises a copolymer and a homopolymer (autopolymer). Unless otherwise specified, the degree of polymerization (the conversion rate) of the polymer is not limited. For example, the polymer may be a completely polymerized polymer (with a conversion rate of 100%) or may be a partially polymerized polymer (with a conversion rate, such as but not limited to 10%-90%, also referred to as a “prepolymer” in the present invention).

In the present invention, the resin composition obtained by first polymerizing different compounds to form a polymer followed by addition the polymer to a resin composition differs from the one obtained by directly and separately adding these compounds to a resin composition without prior polymerization. For example, resin composition 1 is obtained by adding a polymer of compound A and compound B, while resin composition 2 is obtained by separately adding compound A and compound B without prior polymerization. The resin composition 1 and the resin composition 2 are different resin compositions, and the articles obtained therefrom and the properties thereof are also different.

The present invention will be described hereinafter by way of embodiments and Examples.

As noted before, the present invention discloses a resin composition, comprising:
(A) 100 parts by weight of maleimide represented by Formula (1),
(B) 10 to 30 parts by weight of a (meth)acrylate monomer having a triazine ring and/or an oligomer thereof, and
(C) 5 to 15 parts by weight of an allylphenolic compound,

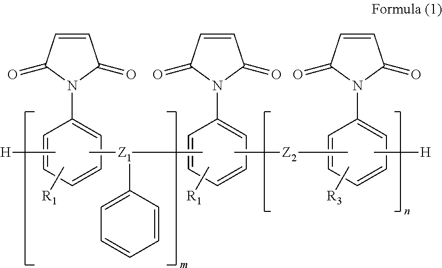

wherein in Formula (1), R₁ and R₃ each independently represent a C2-C5 alkyl group (such as ethyl, propyl, butyl or pentyl, preferably ethyl), R₂ represents a hydrogen atom or a C1-C5 alkyl group (such as methyl, ethyl, propyl, butyl or pentyl, preferably ethyl), m is a value of 1 to 10, n is a value of 1 to 10, and Z₁ and Z₂ each independently represent a C1-C5 alkylene group (such as methylene, ethylene, propylene, butylene or pentylene, preferably methylene).

The additive amount of each component in the resin composition of the present invention is calculated based on a total of 100 parts by weight of the maleimide represented by Formula (1). For example, relative to 100 parts by weight of the maleimide represented by Formula (1), the amount of the (meth)acrylate monomer having a triazine ring and/or an oligomer thereof is 10 to 30 parts by weight, such as but not limited to 10 parts by weight, 11 parts by weight, 12.5 parts by weight, 15 parts by weight, 20 parts by weight, 25 parts by weight, and 30 parts by weight; relative to 100 parts by weight of the maleimide represented by Formula (1), the amount of the allylphenolic compound is 5 to 15 parts by weight, such as but not limited to 5 parts by weight, 6 parts by weight, 7 parts by weight, 8 parts by weight, 9 parts by weight, 10 parts by weight, 11 parts by weight, 12.1 parts by weight, 13.9 parts by weight, 14.5 parts by weight, and 15 parts by weight.

In one preferred embodiment, the aforementioned maleimide represented by Formula (1) comprises maleimide represented by Formula (1-1),

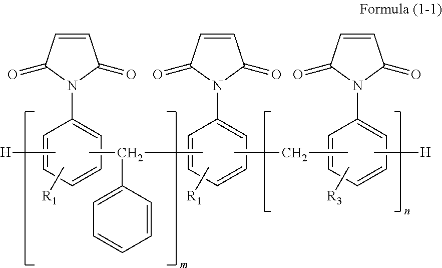

wherein in Formula (1-1), R₁ and R₃ each independently represent a C2-C5 alkyl group (such as ethyl, propyl, butyl or pentyl, preferably ethyl), R₂ represents a hydrogen atom or a C1-C5 alkyl group (such as methyl, ethyl, propyl, butyl or pentyl, preferably ethyl), m is a value of 1 to 10, and n is a value of 1 to 10.

In one preferred embodiment, the aforementioned (meth)acrylate monomer having a triazine ring and/or an oligomer thereof comprises any one or a combination of two or more of an acrylate monomer represented by Formula (A) and/or an oligomer thereof, and an acrylate monomer represented by Formula (B) and/or an oligomer thereof:

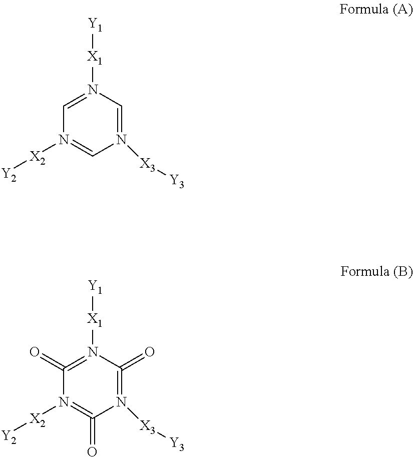

wherein in Formula (A) and Formula (B), X₁ to X₃ each independently represent a C1 to C5 alkylene group (such as methylene, ethylene, propylene, butylene or pentylene, preferably ethylene), and Y₁ to Y₃ each independently represent an acrylate group or a methacrylate group.

In one preferred embodiment, the aforementioned (meth)acrylate monomer having a triazine ring and/or an oligomer thereof comprises any one or a combination of two or more of an acrylate monomer represented by Formula (2.1) and/or an oligomer thereof to an acrylate monomer represented by Formula (2.4) and/or an oligomer thereof.

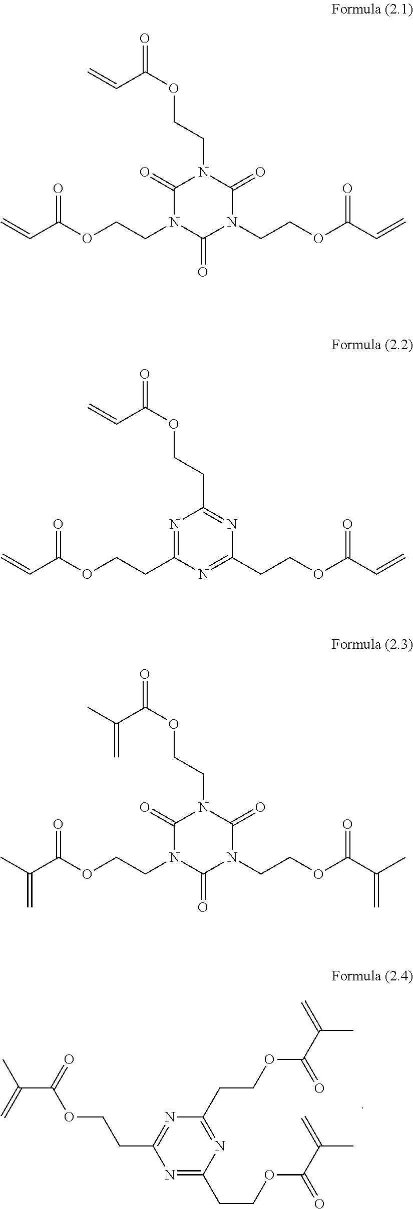

In one preferred embodiment, the aforementioned (meth)acrylate monomer having a triazine ring and/or an oligomer thereof comprises any one or a combination of two or more of an acrylate monomer represented by Formula (2.1) and/or an oligomer thereof to an acrylate monomer represented by Formula (2.2) and/or an oligomer thereof.

In one preferred embodiment, the aforementioned allylphenolic compound comprises any one or a combination of two or more of allyl bisphenol A, allyl bisphenol F, allyl biphenol, and allyl fluorenol.

In one preferred embodiment, the aforementioned allylphenolic compound comprises any one or a combination of two or more of allylphenol represented by Formula (3.1) to allylphenol represented by Formula (3.6):

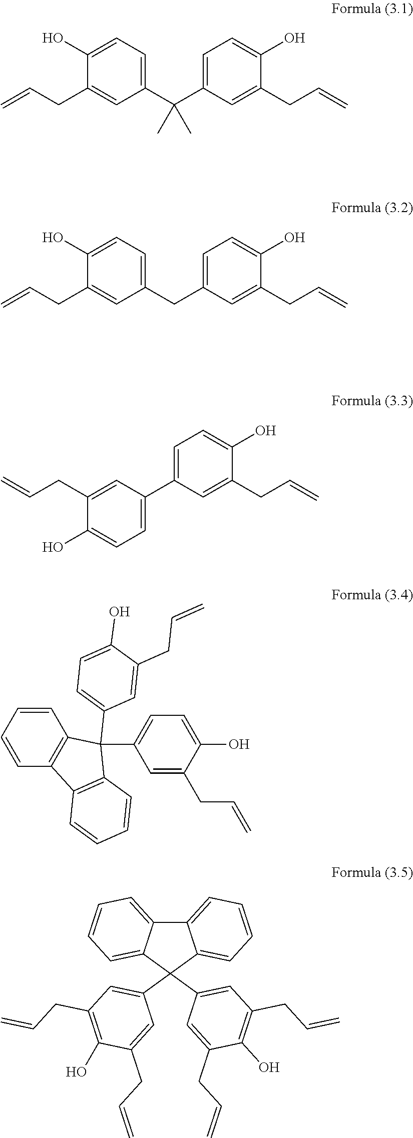

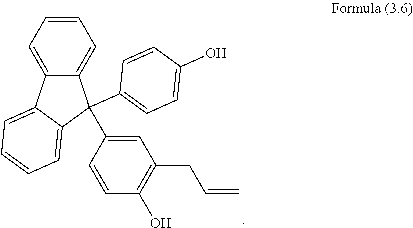 [SMILES: C=CCc1cc(C2(c3ccc(O)cc3)c3ccccc3-c3ccccc32)ccc1O]

In one preferred embodiment, the aforementioned allylphenolic compound comprises any one or a combination of two or more of allylphenol represented by Formula (3.1) to allylphenol represented by Formula (3.3).

In one preferred embodiment, the resin composition further comprises an epoxy resin, with the mass ratio of the epoxy resin to the allylphenolic compound being 1:1 to 1:7, preferably being 1:1 to 1:4.

In the present invention, the epoxy resin may be any epoxy resins known in the field. The epoxy resin includes, but is not limited to, any one or a combination of two or more of bisphenol A epoxy resin, bisphenol F epoxy resin, bisphenol S epoxy resin, bisphenol AD epoxy resin, phenol novolac epoxy resin, bisphenol A novolac epoxy resin, bisphenol F novolac epoxy resin, bisphenol S novolac epoxy resin, bisphenol AD novolac epoxy resin, o-cresol novolac epoxy resin, phenol-aralkyl epoxy resin, naphthalene epoxy resin, biphenyl epoxy resin, dicyclopentadiene epoxy resin, benzofuran epoxy resin, isocyanate epoxy resin, and DOPO epoxy resin. In terms of improving the heat resistance of the resin composition, the epoxy resin preferably comprises any one or a combination of two or more of phenol novolac epoxy resin, bisphenol A novolac epoxy resin, bisphenol F novolac epoxy resin, bisphenol S novolac epoxy resin, bisphenol AD novolac epoxy resin, o-cresol novolac epoxy resin, dicyclopentadiene epoxy resin, naphthalene epoxy resin, biphenyl epoxy resin, and phenol-aralkyl epoxy resin.

The bisphenol A epoxy resin, bisphenol F epoxy resin, bisphenol S epoxy resin, and bisphenol AD epoxy resin refer to epoxy resins generated by reaction of bisphenol A, bisphenol F, bisphenol S, and bisphenol AD with halogenated epoxy compounds (including, but not limited to, epoxy chloropropane) respectively.

The phenol novolac epoxy resin, bisphenol A novolac epoxy resin, bisphenol F novolac epoxy resin, bisphenol S novolac epoxy resin, bisphenol AD novolac epoxy resin, and o-cresol novolac epoxy resin refer to novolac epoxy resins generated by reaction of phenol, bisphenol A, bisphenol F, bisphenol S, bisphenol AD, and o-cresol with aldehyde compounds (including, but not limited to, formaldehyde) and halogenated epoxy compounds (including, but not limited to, epoxy chloropropane) respectively.

The phenol-aralkyl epoxy resin includes, but is not limited to, the following structure, wherein n=1 to 20.

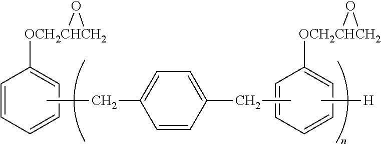

The naphthalene epoxy resin, biphenyl epoxy resin, dicyclopentadiene epoxy resin, benzofuran epoxy resin, isocyanate epoxy resin, and DOPO epoxy resin refer to epoxy resins comprising a naphthalene group, a biphenyl group, a dicyclopentadienyl group, a benzofuran group, an isocyanate group, and a DOPO (9,10-dihydro-9-oxa-10-phosphaphenanthrene-10-oxide) group, respectively.

In one embodiment, the resin composition of the present invention further comprises any one or a combination of two or more of polyolefin, polyester resin, polyphenylene ether resin, silicone resin, benzoxazine resin, phenolic resin, amine curing agent, polyamide, polyimide, styrene maleic anhydride, cyanate ester, and maleimide triazine resin (a polymer of cyanate ester and maleimide resin).

In one embodiment, in the resin composition of the present invention, relative to 100 parts by weight of the maleimide represented by Formula (1), the amount of polyolefin, polyester resin, polyphenylene ether resin, silicone resin, benzoxazine resin, phenolic resin, polyamide, polyimide, styrene maleic anhydride, cyanate ester, and maleimide triazine resin is not particularly limited, and may be adjusted as needed, for example 1 to 100 parts by weight, including but not limited to, 1 part by weight, 10 parts by weight, 15 parts by weight, 20 parts by weight, 25 parts by weight, 50 parts by weight or 100 parts by weight. Relative to 100 parts by weight of the maleimide represented by Formula (1), the amount of the amine curing agent is also not particularly limited, and may be for example 1 to 30 parts by weight, including but not limited to, 1 part by weight, 4 parts by weight, 7.5 parts by weight, 12 parts by weight or 30 parts by weight.

In one embodiment, the polyolefin of the present invention includes, but is not limited to, any one or a combination of two or more of a monoene polymer, a diene polymer, and a hydrogenated diene polymer. The hydrogenated diene polymer refers to a diene polymer in which an unsaturated carbon-carbon double bond has been hydrogenated. The monoene refers to a hydrocarbon compound containing one unsaturated carbon-carbon double bond in the molecule, and the diene refers to a hydrocarbon compound containing two unsaturated carbon-carbon double bonds in the molecule. The polyolefin suitable for the present invention for example includes, but is not limited to, any one or a combination of two or more of polybutadiene, polyisoprene, styrene-butadiene copolymer, styrene-isoprene copolymer, styrene-butadiene-divinylbenzene polymer, divinylbenzene-styrene-ethylstyrene copolymer, divinylbenzene-styrene-ethylene copolymer, styrene-butadiene polymer adducted with maleic anhydride, vinyl-polybutadiene-urethane polymer, polybutadiene adducted with maleic anhydride, polymethylstyrene, hydrogenated polybutadiene, hydrogenated polyisoprene, hydrogenated styrene-butadiene-divinylbenzene polymer, hydrogenated styrene-butadiene polymer adducted with maleic anhydride, hydrogenated styrene-butadiene copolymer, and hydrogenated styrene-isoprene copolymer. Among them, the divinylbenzene-styrene-ethylstyrene copolymer used in the present invention may include various divinylbenzene-styrene-ethylstyrene copolymers disclosed in the US patent application US20070129502A1.

In one embodiment, the polyester resin in the present invention may be any polyester resins known in the field, including but not limited to, any one or a combination of two of a dicyclopentadiene structure-containing polyester resin and a naphthalene ring structure-containing polyester resin. Examples include, but are not limited to, polyester resins sold by D.I.C. Corporation under the trade name HPC-8000 or HPC-8150.

In one embodiment, the polyphenylene ether resin in the present invention includes, but is not limited to, any one or a combination of two or more of hydroxy polyphenylene ether resin, vinylbenzyl polyphenylene ether resin, (meth)acryloyl polyphenylene ether resin, vinyl polyphenylene ether resin, and allyl polyphenylene ether resin. Examples include polyphenylene ether resins commercially available from Mitsubishi Gas Chemical Co., Inc. under the trade names OPE-2st 1200 and OPE-2st 2200, and polyphenylene ether resins commercially available from Sabic under the trade names SA9000 and SA90.

In one embodiment, the silicone resin in the present invention includes, but is not limited to, any one or a combination of two or more of polyalkyl silicone resin, polyaryl silicone resin, polyalkylaryl silicone resin, and modified silicone resin. The modified silicone resin includes, but is not limited to, any one or a combination of two or more of amino-modified silicone resin, epoxy-modified silicone resin, methacryloyl-modified silicone resin, hydroxyl-modified silicone resin, and carboxyl-modified silicone resin. Preferably, the amino-modified silicone resin suitable for the present invention includes, for example, any one or a combination of two or more of amino-modified silicone resins produced by Shin-Etsu Chemical Co., Ltd. under the trade names such as KF-8010, X-22-161A, X-22-161B, KF-8012, KF-8008, X-22-9409, and X-22-1660B-3, amino-modified silicone resins produced by Dow Chemical Company under the trade name such as BY 16-853 U, and amino-modified silicone resins produced by Momentive Performance Materials Japan LLC under the trade names such as XF42-C5742, XF42-C6252, and XF42-C5379. The epoxy-modified silicone resin suitable for the present invention includes, for example, the series produced by Shin-Etsu Chemical Co., Ltd. under the trade name X-22-163. The methacryloyl-modified silicone resin suitable for the present invention includes, for example, the series produced by Shin-Etsu Chemical Co., Ltd. under the trade name X-22-164.

In one embodiment, the benzoxazine resin in the present invention includes, but is not limited to, any one or a combination of two or more of bisphenol A benzoxazine resin, bisphenol F benzoxazine resin, phenolphthalein benzoxazine resin, dicyclopentadiene benzoxazine resin, phosphorus-containing benzoxazine resin, diamino benzoxazine resin, phenyl group-modified benzoxazine resin, vinyl group-modified benzoxazine resin, and allyl group-modified benzoxazine resin. Commercially available benzoxazine resin products suitable for use include LZ 8270 (phenolphthalein benzoxazine resin), LZ 8298 (modified benzoxazine resin), LZ 82818 (bisphenol F benzoxazine resin) and LZ 82919 (bisphenol A benzoxazine resin) sold by Huntsman, or KZH-5031 (allyl-modified benzoxazine resin) and KZH-5032 (phenyl-modified benzoxazine resin) sold by Kolon Industries Inc. Among them, the diamino benzoxazine resin may be any one or a combination of two or more of diaminodiphenylmethane benzoxazine resin, diaminodiphenyl ether benzoxazine resin, diaminodiphenyl sulfone benzoxazine resin, and diaminodiphenyl sulfide benzoxazine resin.

In one embodiment, the phenolic resin in the present invention may be any phenolic resins known in the field, including but not limited to, any one or a combination of two or more of phenol novolac resin, o-cresol novolac resin, bisphenol A novolac resin, naphthol novolac resin, biphenyl novolac resin, dicyclopentadiene phenol resin, and phenoxy resin.

In one embodiment, the amine curing agent in the present invention may be any amine curing agents known in the field, including but not limited to, any one or a combination of two or more of diamino diphenyl sulfone, diamino diphenyl methane, diamino diphenyl ether, diamino diphenyl sulfide, and dicyandiamide.

In one embodiment, the polyamide in the present invention may be any polyamides known in the field, including but not limited to, various commercially available polyamide resin products.

In one embodiment, the polyimide in the present invention may be any polyimides known in the field, including but not limited to, various commercially available polyimide resin products.

In one embodiment, the styrene maleic anhydride (SMA) in the present invention may be any styrene maleic anhydrides known in the field, wherein the molar ratio of styrene to maleic anhydride may be 1/1, 2/1, 3/1, 4/1, 6/1, 8/1 or 12/1. Examples include, but are not limited to, styrene maleic anhydride copolymers such as XIRAN 1000, XIRAN 2000, XIRAN 3000, XIRAN EF40, and XIRAN EF80 produced and sold by Aurorium.

In one embodiment, the cyanate ester in the present invention may be any cyanate ester resins known in the field, such as a compound having an Ar—O—C≡N structure, wherein Ar may be a substituted or unsubstituted aromatic group. In terms of improving the heat resistance of the resin composition, examples include, but are not limited to, any one or a combination of two or more of novolac cyanate ester resin, bisphenol A cyanate ester resin, bisphenol F cyanate ester resin, dicyclopentadiene structure-containing cyanate ester resin, naphthalene ring structure-containing cyanate ester resin, phenolphthalein cyanate ester resin, adamantane cyanate ester resin, and fluorene cyanate ester resin. Among them, the novolac cyanate ester resin includes any one or a combination of two or more of bisphenol A novolac cyanate ester resin and bisphenol F novolac cyanate ester resin. Examples of commercialized cyanate ester resins include, but are not limited to, Primaset PT-15, PT-30, PT-30S, PT-60, PT-60S, BA-200, BA-230S, BA-3000, BA-3000S, BA-4000, BA-4000S, DT-4000, DT-7000, ULL-950S, HTL-300, LVT-50, LVT-100, LECy, and other cyanate ester resins produced and sold by Arxada AG.

In one embodiment, the maleimide triazine resin (a polymer of cyanate ester and maleimide resin) in the present invention may be any maleimide triazine resins known in the field, such as including but not limited to any one or a combination of two or more of a maleimide triazine resin obtained by polymerization of maleimide resin and bisphenol A cyanate ester resin, a maleimide triazine resin obtained by polymerization of maleimide resin and bisphenol F cyanate ester resin, a maleimide triazine resin obtained by polymerization of maleimide resin and phenol novolac cyanate ester resin, and a maleimide triazine resin obtained by polymerization of maleimide resin and dicyclopentadiene structure-containing cyanate ester resin. In one embodiment, the maleimide triazine resin may be obtained by polymerization of the maleimide resin and the aforementioned cyanate ester resin at any molar ratio. The molar ratio of the maleimide resin to the cyanate ester resin may be 1:1 to 10, for example including but not limited to, 1:1, 1:2, 1:4, 1:6, 1:8 or 1:10.

In one embodiment, the resin composition of the present invention further comprises any one or a combination of two or more of a flame retardant, a curing accelerator, a polymerization inhibitor, an inorganic filler, a solvent, a silane coupling agent, a surfactant, a coloring agent, and a toughening agent.

In one embodiment, the flame retardant of the present invention may be any one or a combination of two or more of flame retardants known in the field suitable for preparing a prepreg, a resin film, a metallic clad laminate or a printed circuit board, for example including but not limited to, a phosphorus-containing flame retardant or a bromine-containing flame retardant. The bromine-containing flame retardant preferably comprises decabromodiphenyl ethane. The phosphorus-containing flame retardant preferably comprises: any one or a combination of two or more of hydroquinone bis-(diphenyl phosphate), bisphenol A bis-(diphenylphosphate), tri(2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDX, such as commercially available products PX-200, PX-201, and PX-202), ammonium polyphosphate, melamine polyphosphate, 9,10-dihydro-9-oxa-10-phosphaphenanthrene-10-oxide (DOPO) compounds and derivatives or resins thereof (such as di-DOPO compounds), diphenylphosphine oxide (DPPO) compounds and derivatives or resins thereof (such as di-DPPO compounds), melamine cyanurate, trishydroxyethyl isocyanurate, and aluminium phosphinate (e.g., commercially available products OP-930 and OP-935).

In one embodiment, the flame retardant in the present invention may be a flame retardant sold by Katayama Chemical Industries Co., Ltd., such as including but not limited to any one or a combination of two or more of V1, V2, V3, V4, V5, V7, S-2, S-4, E-4c, E-7c, E-8g, E-9g, E-10g, E-100, B-3, W-1o, W-2h, W-2o, W-3o, W-4o, OX-1, OX-2, OX-4, OX-6, OX-6+, OX-7, OX-7+, OX-13, BPE-1, BPE-3, HyP-2, API-9, CMPO, ME-20, C-1R, C-1S, C-3R, C-3S, and C-11R.

In one embodiment, relative to 100 parts by weight of the maleimide represented by Formula (1), the resin composition of the present invention may further comprise 1 to 100 parts by weight of a flame retardant, preferably 5 to 80 parts by weight of a flame retardant, and more preferably 5 to 50 parts by weight of a flame retardant.

In one embodiment, relative to 100 parts by weight of the maleimide represented by Formula (1), the resin composition of the present invention may further comprise 0.001 to 5 parts by weight of a curing accelerator, preferably 0.01 to 3 parts by weight of a curing accelerator, and more preferably 0.1 to 1.8 parts by weight of a curing accelerator. The curing accelerator comprises a catalyst such as a Lewis base or a Lewis acid, and a curing initiator (or an initiator). Among them, the Lewis base comprises any one or a combination of two or more of imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MZ), triphenylphosphine (TPP), and 4-dimethylaminopyridine (DMAP). The Lewis acid comprises metal salt compounds, such as the metal salts of manganese, iron, cobalt, nickel, copper, and zinc, specifically the metal salt catalysts of zinc such as zinc octanoate and cobalt octanoate. The curing initiator comprises a peroxide capable of producing free radicals, such as but not limited to any one or a combination of two or more of dicumyl peroxide (DCP), tert-butyl peroxybenzoate, dibenzoyl peroxide (BPO), 2,5-dimethyl-2,5-di(tert-butylperoxy)-3-hexyne (DYBP), di-tert-butyl peroxide (DTBP), and bis(tert-butylperoxyisopropyl) benzene.

In one embodiment, relative to 100 parts by weight of the maleimide represented by Formula (1), the resin composition of the present invention may further comprise 0.001 to 20 parts by weight of a polymerization inhibitor, preferably 0.001 to 10 parts by weight of a polymerization inhibitor, and more preferably 0.001 to 1 part by weight of a polymerization inhibitor. The polymerization inhibitor includes, but is not limited to, any one or a combination of two or more of 2,2-diphenyl-1-picrylhydrazyl (DPPH), methyl acrylonitrile, nitroxide-mediated free radical polymerization inhibitor, triphenylmethyl free radical polymerization inhibitor, metal ion free radical polymerization inhibitor, sulfur free radical polymerization inhibitor (for example including but not limited to, dithioester), hydroquinone, p-methoxyphenol, p-benzoquinone, phenothiazine, 0-phenylnaphthylamine, p-tert-butylcatechol, methylene blue, 4,4′-butylidenebis(6-tert-butyl-3-methylphenol), 2,2′-methylenebis(4-ethyl-6-tert-butylphenol), and galvinoxyl free radical polymerization inhibitor. Among them, the nitroxide-mediated free radical polymerization inhibitor includes, but is not limited to, 2,2,6,6-tetramethyl-1-oxo-piperidine, nitroxide free radical polymerization inhibitors derived from cyclic hydroxylamines (such as 2,2,6,6-substituted piperidine 1-oxyl free radical polymerization inhibitor, and 2,2,5,5-substituted pyrrolidine 1-oxyl free radical polymerization inhibitor, wherein the substitute is preferably a C1-C4 alkyl group such as a methyl group). The specific nitroxide free radical polymerization inhibitor includes any one or a combination of two or more of 2,2,6,6-tetramethylpiperidine 1-oxyl free radical polymerization inhibitor, 2,2,6,6-tetraethylpiperidine 1-oxyl free radical polymerization inhibitor, 2,2,6,6-tetramethyl-4-oxo-piperidine 1-oxyl free radical polymerization inhibitor, 2,2,5,5-tetramethylpyrrolidine 1-oxyl free radical polymerization inhibitor, 1,1,3,3-tetramethyl-2-isoindoline oxygen free radical polymerization inhibitor, and N,N-di-tert-butylamine oxygen free radical polymerization inhibitor. The polymerization inhibitor suitable for the resin composition of the present invention further includes derivatives of the polymerization inhibitor with its hydrogen atom or group substituted. Examples include derivatives of the polymerization inhibitor with its hydrogen atom substituted by an amino group, a hydroxyl group, a carbonyl group or the like.

In one embodiment, relative to 100 parts by weight of the maleimide represented by Formula (1), the resin composition of the present invention may further comprise 10 to 300 parts by weight of an inorganic filler, preferably 80 to 300 parts by weight of an inorganic filler, and more preferably 200 to 300 parts by weight of an inorganic filler. The inorganic filler may be any one or more inorganic fillers suitable for preparing a prepreg, a resin film, a metallic clad laminate or a printed circuit board, examples thereof including but not limited to, any one or a combination of two or more of silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate modified talc, zinc oxide, zirconium oxide, mica, boehmite (AlOOH), calcined talc, talc, silicon nitride, zirconium tungstate, petalite, and calcined kaolin. The shape of the inorganic filler is not particularly limited, and may be spherical (including solid sphere or hollow sphere), fibrous, plate-like, particulate, flake-like or whisker-like. The inorganic filler is preferably pretreated by a silane coupling agent on the surface. The color of the inorganic filler is not particularly limited, and may be various colors such as white, black or faint yellow. The method for preparing the inorganic filler is also not particularly limited. For example, the method for preparing spherical silicon dioxide (abbreviated as “spherical silica”) may be a known method such as melting method, chemical synthesis method, and direct combustion method.

In one embodiment, the solvent in the resin composition of the present invention includes any one of the following solvents: methanol, ethanol, ethylene glycol monomethyl ether, acetone, butanone (also referred to as methyl ethyl ketone or MEK), methyl isobutyl ketone, cyclohexanone, N-methyl-pyrrolidone, toluene, xylene, methoxyethyl acetate, ethoxyethyl acetate, propoxyethyl acetate, ethyl acetate, dimethylformamide, dimethylacetamide, and propylene glycol monomethyl ether acetate, or a mixed solvent of two or more of the above. The amount of a solvent is used with the aim of being able to fully dissolve the resin and achieve a specific total solid content of the resin composition through adjustment. In one preferred embodiment, the amount of a solvent allows the total solid content of the resin composition to be 50 to 85 wt %.

In one embodiment, relative to 100 parts by weight of the maleimide represented by Formula (1), the resin composition of the present invention may further comprise 0.001 to 20 parts by weight of a silane coupling agent, preferably 0.01 to 10 parts by weight of a silane coupling agent. The silane coupling agent comprises silane compound (such as including, but not limited to siloxane compound), which comprises any one or a combination of two or more of amino silane compound, epoxy silane compound, vinyl silane compound, hydroxyl silane compound, isocyanate silane compound, methacryloxy silane compound, and acryloxy silane compound.

In one embodiment, relative to 100 parts by weight of the maleimide represented by Formula (1), the resin composition of the present invention may further comprise 0.001 to 10 parts by weight of a surfactant, preferably 0.01 to 5 parts by weight of a surfactant. The main purpose of adding a surfactant in the present invention is to ensure that the filler can be homogeneously dispersed in the resin composition. The types of the surfactant suitable for the resin composition of the present invention are not particularly limited.

In one embodiment, relative to 100 parts by weight of the maleimide represented by Formula (1), the resin composition of the present invention may further comprise 0.001 to 10 parts by weight of a coloring agent, preferably 0.01 to 5 parts by weight of a coloring agent. The coloring agent includes, but is not limited to, known dyes or pigments.

In one embodiment, relative to 100 parts by weight of the maleimide represented by Formula (1), the resin composition of the present invention may further comprise 1 to 50 parts by weight of a toughening agent, preferably 3 to 30 parts by weight of a toughening agent. In the present invention, the main purpose of adding a toughening agent is to improve the toughness of the resin composition. The toughening agent suitable for the present invention includes, but is not limited to, any one or a combination of two or more of carboxyl-terminated butadiene acrylonitrile rubber (such as CTBN), core-shell rubber, ethylene propylene rubber, and other compounds.

The present invention further provides an article made from the aforementioned resin composition, such as a component suitable for use in various electronic products, including a prepreg, a resin film, a metallic clad laminate or a printed circuit board.

The resin composition of the present invention can be used to make a prepreg, which comprises a reinforcement material and a layered structure disposed thereon. The layered structure is formed by heating the aforementioned resin composition at a high temperature to the B-stage. The baking temperature for making a prepreg is 120 to 180 °C (preferably 120 to 160 °C). The reinforcement material may be any one of a fiber material, woven fabric, and non-woven fabric, wherein the woven fabric preferably comprises fiberglass fabrics. The types of fiberglass fabrics are not particularly limited, and may be various fiberglass fabrics suitable for printed circuit boards, such as E-glass fabric, D-glass fabric, S-glass fabric, T-glass fabric, L-glass fabric, Q-glass fabric or QL-glass fabric (a glass fabric with a hybrid structure made of Q-glass and L-glass); the fiber may comprise yarns and rovings, in spread form or standard form, and the shape of terminal face may be round or flat. The aforementioned non-woven fabric preferably comprises liquid crystal polymer non-woven fabric, such as polyester non-woven fabric, polyurethane non-woven fabric and so on. The aforementioned woven fabric may also comprise liquid crystal polymer woven fabric, such as polyester woven fabric or polyurethane woven fabric and so on. The reinforcement material may increase the mechanical strength of the prepreg. In one preferred embodiment, the reinforcement material is pre-treated by a silane coupling agent on the surface. The prepreg is further heated and cured to form a C-stage layer.

The resin composition of the present invention can be used to make a resin film, which is prepared by heating and baking to semi-cure the aforementioned resin composition. The resin composition may be selectively coated on a support material, followed by heating and baking to semi-cure the resin composition to form the resin film. The support material therein includes, but is not limited to, a liquid crystal polymer film, a polytetrafluoroethylene film, a polyethylene terephthalate film (PET film), a polyimide film (PI film), a metal foil (such as a copper foil) or a resin-coated metal (such as resin-coated copper, RCC) foil.

The resin composition of the present invention may be made into various metallic clad laminates, which comprise at least two metal foils and at least one layer disposed between the two metal foils, wherein the layer is made by curing the aforementioned resin composition at high temperature and high pressure to the C-stage, a suitable curing temperature being for example 190 to 250 °C (preferably 200 to 220 °C), a suitable curing time being 90 to 180 minutes (preferably 120 to 150 minutes), and a suitable lamination pressure being for example 300 to 550 psi (preferably 400 to 500 psi). The aforementioned layer may be obtained by curing the aforementioned prepreg or resin film. The aforementioned metal foil may contain copper, aluminum, nickel, platinum, silver, gold or alloy thereof, such as copper. In one preferred embodiment, the metallic clad laminate is a copper-clad laminate (also referred to as “CCL”).

In one embodiment, the aforementioned metallic clad laminate may be further processed by trace formation processes to obtain a printed circuit board. In one embodiment, the step of manufacturing a printed circuit board includes: (1) selecting a double-sided copper-clad laminate (such as product EM-827, commercially available from Elite Electronic Material) with a thickness of 28 mil and having a 1-ounce (oz) HTE (high temperature elongation) copper foil, and subjecting it to drilling (the means of drilling, such as but not limited to mechanical drilling or laser drilling) and then electroplating, so as to form electrically conductive vias between the top layer copper foil and the bottom layer copper foil; (2) etching the top layer copper foil and the bottom layer copper foil to form inner layer circuits; (3) performing brown oxidation and roughening on the inner layer circuits to form uneven structures on the surface to increase roughness, and form an inner layer circuit board; and (4) using a vacuum lamination apparatus to laminate an assembly of one copper foil, one aforementioned prepreg (or one aforementioned resin film), one aforementioned inner layer circuit board, one aforementioned prepreg (or one aforementioned resin film), and one copper foil stacked in that order by heating at a temperature of 190 to 220 °C for 90 to 180 minutes to completely cure the B-stage layer material, thereby obtaining the printed circuit board. Optionally, the resulting printed circuit board is further subjected to various subsequent processings known in this field, such as black oxidation, drilling, and copper plating.

In one embodiment, the article made from the aforementioned resin composition has a reinforcement material or a support material and a semi-cured or cured product obtained by subjecting the aforementioned resin composition to heating and chemical crosslinking.

In one embodiment, various articles prepared from the resin composition disclosed in the present invention have at least one of the following properties:
a deduction for resin agglomeration of ≤5 points, for example, a deduction of 3 to 5 points;
an in-plane resin flow length of 7.0 to 9.0 mm, for example, 7.1 to 9.0 mm;
having no voids and no dendritic patterns after a resin filling property test;
a resin flow decay rate of ≤4.0%, for example, 2.8 to 3.6%;
an storage modulus decay rate as measured and calculated by reference to the method stated in IPC-TM-650 2.4.24.4 of ≤40%, for example, 33 to 39%; and
a peel strength as measured by reference to the method stated in IPC-TM-650 2.4.8 of ≥4.0 lb/in, for example, 4.1 to 4.9 lb/in.

### EXAMPLES

The concept and the technical effect of the present invention achieved are further described below in conjunction with the Examples, so that those skilled in the art can fully understand the purposes, features and effects of the present invention.

The raw materials used in the Examples and Comparative Examples of the present invention are as follows:
Maleimide of Formula (1.1): commercially available, with the structural formula as shown in the preceding Formula (1-1), wherein Z₁ and Z₂ are methylene, R₁ to R₃ represent ethyl, m is a value of 1 to 10, and n is a value of 1 to 10.
Maleimide of Formula (1.2): commercially available, with the structural formula as shown in the preceding Formula (1-1), wherein Z₁ and Z₂ are methylene, R₁ to R₃ represent tert-butyl, m is a value of 1 to 10, and n is a value of 1 to 10.
Acrylate of Formula (2.1): with the structural formula as shown in the preceding Formula (2.1), purchased from Sartomer under the trade name SR368NS.
Oligomer of acrylate of Formula (2.1): obtained by polymerization reaction of acrylate of Formula (2.1), with a weight average molecular weight of less than 2,000.
Acrylate of Formula (2.2): with the structural formula as shown in the preceding Formula (2.2), commercially available, the structural formula having been previously described.
TAIC: triallyl isocyanurate monomer, purchased from Kingyorker Enterprise Co., Ltd.
DCP: tricyclodecane dimethanol dimethacrylate, purchased from Shin Nakamura Chemical Co., Ltd.
Allylphenol of Formula (3.1): with the structural formula as previously described, purchased from Shandong Laiyu Chemical Co., Ltd.
Allylphenol of Formula (3.2): commercially available, with the structural formula as previously described.
Allylphenol of Formula (3.3): commercially available, with the structural formula as previously described.
HP-7200: dicyclopentadiene epoxy resin, purchased from DIC Corporation.
NC-3000: biphenyl epoxy resin, purchased from Nippon Kayaku Co., Ltd.
NC-7000L: naphthalene epoxy resin, purchased from Nippon Kayaku Co., Ltd.
BNE-200: bisphenol A novolac epoxy resin, purchased from Chang Chun Plastics Co., Ltd.
Maleimide of Formula (4): maleimide resin containing a biphenyl structure, commercially available, with the following formula:

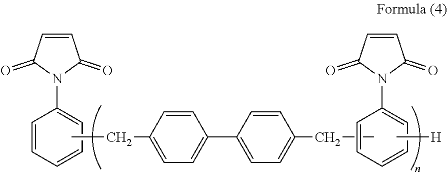

In Formula (4), n is a value of 1 to 10.
BMI-3000: maleimide containing an aliphatic structure with 10 to 50 carbon atoms, purchased from Designer Molecules Inc.
BMI-80: 2,2-bis(4-(4-maleimidephenoxy)phenyl)propane, purchased from K.I Chemical Industry Co., Ltd.
BMI-2300: polyphenylmethane maleimide, purchased from Daiwakasei Industry Co., Ltd., with the following formula, wherein n is a value of 1 to 10:

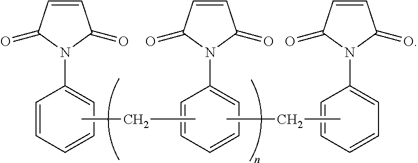

25B: 2,5-dimethyl-2,5-di(tert-butylperoxy)-3-hexyne, purchased from NOF Corporation.
Spherical silica prepared by chemical synthesis: spherical silicon dioxide prepared by chemical synthesis and treated with a silane coupling agent on the surface, with a median particle size D₅₀ of about 1.5±0.5 microns, commercially available.
MEK solvent: commercially available. The amount of solvent is shown as “PA (proper amount)” to represent an amount of the solvent adjusted to achieve a 60 to 68 wt % total solid content of the resin composition.

Raw material compositions and property test results of the Examples and Comparative Examples of the present invention are listed in Tables 1-2.

TABLE 1
Raw material compositions of resin compositions of Examples E1 to E15 (in part by weight) and property test results

| Components | | E1 | E2 | B3 | E4 | E5 | E6 | E7 | E8 | E9 | E10 | E11 | E12 | E13 | E14 | E15 |
|---|---|---|---|---|---|---|---|---|---|---|---|---|---|---|---|---|
| Maleimide resin | Maleimide of | 100 | 100 | 100 | 100 | 100 | 100 | 100 | 100 | 100 | | 100 | | 100 | 50 | |
| | Formula (1.1) | | | | | | | | | | | | | | | |
| | Maleimide of | | | | | | | | | | 100 | | 100 | | 50 | 20 |
| | Formula (1.2) | | | | | | | | | | | | | | | |
| Crosslinking agent | Acrylate of | 15 | 15 | 15 | 10 | 30 | 15 | 15 | 15 | 15 | | 25 | | | 15 | 5 |
| | Formula (2.1) | | | | | | | | | | | | | | | |
| | Oligomer of acrylate | | | | | | | | | | | | 20 | | 5 | 10 |
| | of Formula (2.1) | | | | | | | | | | | | | | | |
| | Acrylate of | | | | | | | | | | 20 | | | 15 | | |
| | Formula (2.2) | | | | | | | | | | | | | | | |
| | TAIC | | | | | | | | | | | | | | | |
| | DCP | | | | | | | | | | | | | | | |
| Allylphenolic | Allylphenol of | 5 | 15 | 10 | 10 | 10 | 5 | 5 | 5 | 5 | | | 7 | | | 4 |
| compound | Formula (3.1) | | | | | | | | | | | | | | | |
| | Allylphenol of | | | | | | | | | | 10 | | | 12 | 3 | 2 |
| | Formula (3.2) | | | | | | | | | | | | | | | |
| | Allylphenol of | | | | | | | | | | | 15 | | | | 3 |
| | Formula (3.3) | | | | | | | | | | | | | | | |
| Epoxy resin | HP-7200 | | | | | | | | | | 15 | | | | | 2 |
| | NC-3000 | | | | | | 5 | 10 | 20 | 35 | | | | | 7 | 2 |
| | NC-7000L | | | | | | | | | | | 30 | | 15 | 7 | |
| | BNE-200 | | | | | | | | | | | | 14 | | | 2 |
| Other maleimide | Maleimide of | | | | | | | | | | | | | | | |
| resins | Formula (4) | | | | | | | | | | | | | | | |
| | BMI-3000 | | | | | | | | | | | | | | | |
| | BMI-80 | | | | | | | | | | | | | | | |
| | BMI-2300 | | | | | | | | | | | | | | | |
| Initiator | 25B | 0.5 | 0.5 | 0.5 | 0.5 | 0.5 | 0.5 | 0.5 | 0.5 | 0.5 | 0.5 | 0.5 | 0.5 | 0.5 | 1.0 | 0.1 |
| Inorganic filler | Spherical silica | 240 | 240 | 240 | 240 | 240 | 240 | 240 | 240 | 240 | 240 | 240 | 240 | 240 | 210 | 260 |
| | prepared by | | | | | | | | | | | | | | | |
| | chemical synthesis | | | | | | | | | | | | | | | |
| Solvent | MEK | PA | PA | PA | PA | PA | PA | PA | PA | PA | PA | PA | PA | PA | PA | PA |
| Properties | Unit | E1 | E2 | E3 | E4 | E5 | E6 | E7 | E8 | E9 | E10 | E11 | E12 | E13 | E14 | E15 |
| Resin agglomeration | Points | −3 | −4 | −3 | −4 | −5 | −3 | −3 | −4 | −5 | −4 | −5 | −5 | −4 | −3 | −4 |
| In-plane resin flow | mm | 7.1 | 7.5 | 7.4 | 7.6 | 7.2 | 7.9 | 8.4 | 8.6 | 8.9 | 8.4 | 9.0 | 8.4 | 8.4 | 8.4 | 8.5 |
| length | | | | | | | | | | | | | | | | |
| Resin filling | / | OK | OK | OK | OK | OK | OK | OK | OK | OK | OK | OK | OK | OK | OK | OK |
| property | | | | | | | | | | | | | | | | |
| Resin flow decay | % | 3.4 | 2.8 | 3.0 | 2.8 | 3.4 | 3.5 | 3.4 | 3.5 | 3.6 | 3.2 | 3.6 | 3.0 | 3.4 | 3.4 | 3.5 |
| rate | | | | | | | | | | | | | | | | |
| Storage modulus | % | 34 | 35 | 34 | 34 | 35 | 35 | 37 | 38 | 39 | 38 | 39 | 37 | 33 | 39 | 37 |
| decay rate | | | | | | | | | | | | | | | | |
| Peel strength | lb/in | 4.1 | 4.3 | 4.2 | 4.1 | 4.3 | 4.5 | 4.7 | 4.8 | 4.9 | 4.7 | 4.8 | 4.6 | 4.6 | 4.8 | 4.6 |

TABLE 2
Raw material compositions of resin compositions of Comparative Examples
C1 to C10 (in part by weight) and property test results

| Components | | C1 | C2 | C3 | C4 | C5 | C6 | C7 | C8 | C9 | C10 |
|---|---|---|---|---|---|---|---|---|---|---|---|
| Maleimide resin | Maleimide of Formula (1.1) | 100 | 100 | 100 | 100 | | | | | 100 | 100 |
| | Maleimide of Formula (1.2) | | | | | | | | | | |
| Crosslinking agent | Acrylate of Formula (2.1) | 15 | 15 | 5 | 35 | 15 | 15 | 15 | 15 | | |
| | Oligomer of acrylate of | | | | | | | | | | |
| | Formula (2.1) | | | | | | | | | | |
| | Acrylate of Formula (2.2) | | | | | | | | | | |
| | TAIC | | | | | | | | | 15 | |
| | DCP | | | | | | | | | | 15 |
| Allylphenolic compound | Allylphenol of Formula (3.1) | 0 | 20 | 10 | 10 | 10 | 10 | 10 | 10 | 10 | 10 |
| | Allylphenol of Formula (3.2) | | | | | | | | | | |
| | Allylphenol of Formula (3.3) | | | | | | | | | | |
| Epoxy resin | HP-7200 | | | | | | | | | | |
| | NC-3000 | | | | | | | | | | |
| | NC-7000L | | | | | | | | | | |
| | BNE-200 | | | | | | | | | | |
| Other maleimide resins | Maleimide of Formula (4) | | | | | 100 | | | | | |
| | BMI-3000 | | | | | | 100 | | | | |
| | BMI-80 | | | | | | | 100 | | | |
| | BMI-2300 | | | | | | | | 100 | | |
| Initiator | 25B | 0.5 | 0.5 | 0.5 | 0.5 | 0.5 | 0.5 | 0.5 | 0.5 | 0.5 | 0.5 |
| Inorganic filler | Spherical silica prepared | 240 | 240 | 240 | 240 | 240 | 240 | 240 | 240 | 240 | 240 |
| | by chemical synthesis | | | | | | | | | | |
| Solvent | MEK | PA | PA | PA | PA | PA | PA | PA | PA | PA | PA |
| Properties | Unit | C1 | C2 | C3 | C4 | C5 | C6 | C7 | C8 | C9 | C10 |
| Resin agglomeration | Points | −13 | −27 | −8 | −20 | −15 | −34 | −48 | −15 | −8 | −9 |
| In-plane resin flow length | mm | 2.5 | 11.3 | 9.8 | 3.2 | 4.2 | 13.6 | 9.4 | 5.3 | 8.3 | 7.6 |
| Resin filling property | / | NG | NG | NG | NG | NG | NG | NG | NG | OK | OK |
| Resin flow decay rate | % | 7.3 | 2.8 | 3.2 | 11.2 | 3.4 | 2.8 | 3.2 | 9.5 | 7.8 | 6.4 |
| Storage modulus decay rate | % | 34 | 48 | 48 | 52 | 43 | 90 | 40 | 34 | 43 | 46 |
| Peel strength | lb/in | 3.5 | 4.2 | 3.7 | 4.4 | 3.7 | 3.4 | 3.9 | 4.1 | 3.4 | 3.5 |

For the property tests of the Examples and Comparative Examples of the present invention, the test items (samples) were prepared by reference to the following manners and then tested under specified conditions.

### (1) Varnish

In each of the Examples and Comparative Examples, the respective ingredients were separately added to a stirring tank according to the amounts specified in Tables 1-2 and stirred. The resin composition solution obtained after homogeneous mixing was referred to as varnish.

### (2) Resin-Coated Copper (RCC)

The varnish prepared in each of the Examples and Comparative Examples was uniformly coated on a copper foil (a 3 μm ultra-thin copper foil with an 18 μm carrier copper foil, purchased from Mitsui Mining & Smelting Co., Ltd. under the trade name MT18-FL), so that the resin composition was uniformly adhered thereto, and then subjected to heating and baking at a temperature of 120 °C for 5 minutes to form a semi-cured resin layer, thereby obtaining a resin-coated copper having copper foil layers and a semi-cured resin layer (with a structure of carrier copper foil/ultra-thin copper foil/semi-cured resin layer). A resin-coated copper with a total thickness of 40 μm and a resin-coated copper with a total thickness of 100 m were prepared separately, and designated as RCC (40 μm) and RCC (100 μm), respectively.

### (3) Brown Oxide Treated Core

A copper-clad laminate (for example, the product EM-S530, commercially available from Elite Electronic Material) was prepared, and subjected to the existing copper foil brown oxidation process to obtain a brown oxide treated core.

Test methods and property analysis items for each abovementioned sample to be tested are described as follows:

### 1. Resin Agglomeration

The aforementioned RCC (40 μm) was selected and made into a section with a length of 1.5 cm and a width of 0.5 cm as a sample to be tested, and the size of resin agglomerate in the resin layer was observed and measured using a scanning electron microscope at 400× magnification (as shown in FIG. 1). Scoring (deduction) was conducted according to the following criteria:
(2) 5 μm≤size of resin agglomerate≤10 μm: −1 point (i.e., deduct 1 point for each occurrence);
(3) 10 μm≤size of resin agglomerate≤20 μm: −2 points (i.e., deduct 2 points for each occurrence);
(4) 20 μm≤size of resin agglomerate≤30 μm: −5 points (i.e., deduct 5 points for each occurrence);
(5) 30 μm≤size of resin agglomerate≤50 μm: −10 points (i.e., deduct 10 points for each occurrence).

A combined score was calculated when multiple resin agglomerates were present. For example, if two resin agglomerates are observed in the sample (one with a size of 9 μm and the other with a size of 35 μm), 1 point and 10 points are deducted, respectively, resulting in a combined score of −11 points. This process continued similarly for additional agglomerates. The greater the deductions, the more severe the resin agglomeration.

### 2. In-Plane Resin Flow Length

One aforementioned RCC (100 μm) and one aforementioned brown oxide treated core were selected. The RCC (100 μm) was cut to have a rhombic hole with a side length of 4 inches, and then the RCC was stacked on the brown oxide treated core, the side of the RCC with a semi-cured resin layer adjacently facing one side of the brown oxide treated core, and one HTE copper foil covered on the RCC. They were laminated and cured under vacuum at a temperature of 220 °C and a pressure of 350 psi for 2 hours, followed by cooling to obtain a first copper-containing laminate. Then, the HTE copper foil was removed to obtain an in-plane resin flow sample. The in-plane resin flow sample was taken, with each side of the rhombus serving as a baseline. Each side was divided into four equal parts, resulting in three division points per side. Thus, with four sides, there were a total of 12 division points. The resin flow at each of the 12 division points (the resin flow distance perpendicular to the baseline direction at each division point) was measured, and the average value of resin flow was calculated from 12 division points to obtain the in-plane resin flow length (average value) in millimeters (mm). The in-plane resin flow length was preferably 7.0 to 9.0 mm.

### 3. Resin Filling Property

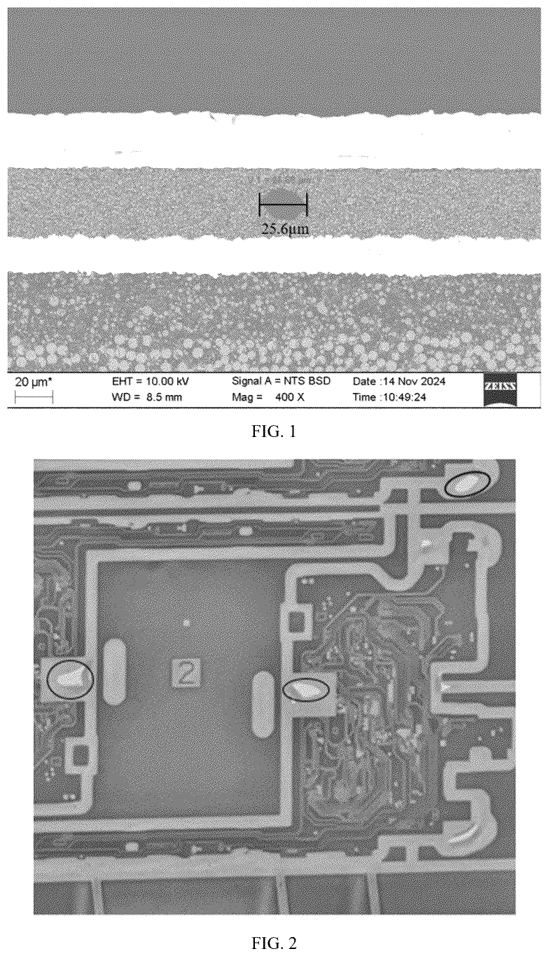

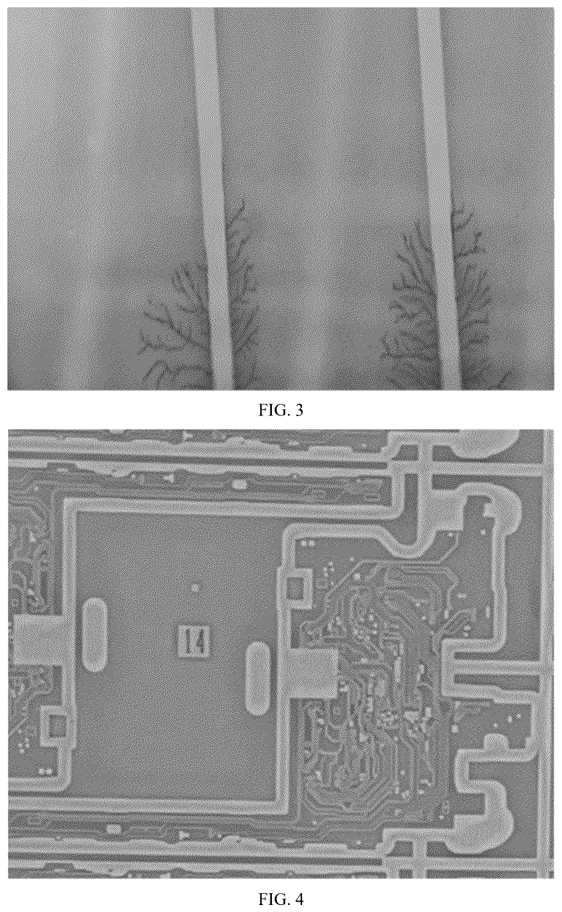

One aforementioned brown oxide treated core was selected, and the copper foils on both sides thereof were etched into traces to obtain a core with a residual copper rate of 65%. Then, each of the two sides of the core was stacked with one RCC (40 μm), and then laminated and cured under vacuum at a temperature of 220 °C and a pressure of 350 psi for 2 hours, followed by cooling to obtain a second copper-containing laminate. After etching away the outer layer copper foils, a laminate without copper on the surface was obtained, and it was then cut into a sample measuring 38.1 cm×50.4 cm. The etched areas of the copper foils on the sample (areas that should be filled with resin) were observed using an optical microscope for any presence of voids or dendritic patterns. “NG” is marked in the case where voids are present (as shown in FIG. 2) or dendritic patterns are present (as shown in FIG. 3), indicating poor resin filling properties. “OK” is marked in the case where no voids and no dendritic patterns are present (as shown in FIG. 4), indicating excellent resin filling properties.

### 4. Resin Flow Decay Rate

Two RCCs (40 μm) with a side length of 10 cm were selected and weighed (the total original weight of the two RCCs was W0, with the total weight of the copper foils being W1). They were stacked together with the resin layers bonded face-to-face, and then laminated under vacuum at a temperature of 171 °C and a pressure of 200 psi for 5 minutes, followed by cooling to obtain a third copper-containing laminate. After the excess resin was removed from the sample, the sample was weighed and the value recorded as W2.

Next, two RCCs (40 μm) with a side length of 10 cm were selected and weighed (the total original weight of the two RCCs was W0, with the total weight of the copper foils being W1). They were refrigerated and stored below 5 °C for 90 days, and then laminated under vacuum at a temperature of 171 °C and a pressure of 200 psi for 5 minutes, followed by cooling to obtain a third copper-containing laminate. After the excess resin was removed from the sample, the sample was weighed and the value recorded as W3.

The resin flow decay rate was calculated as follows:

RF1=(W0−W2)/(W0−W1)×1000%,

RF2=(W0−W3)/(W0−W1)×100%,

Resin flow decay rate=RF1−RF2.

### 5. Storage Modulus Decay Rate

One aforementioned RCC (40 μm) was selected and etched to remove copper foils to obtain a sample to be tested. By reference to the method stated in IPC-TM-650 2.4.24.4, the storage modulus of the sample was measured using a dynamic mechanical analyzer (DMA), wherein the temperature interval during the measurement was set at 35 to 300 °C with a ramp rate of 2 °C/minute. The storage modulus (in MPa) of the sample at 50 °C was recorded and designated as E′50, and the storage modulus (in MPa) of the sample at 250 °C was recorded and designated as E′250. The storage modulus decay rate was calculated as follows: ((E′50−E′250)/E′50)*100%

### 6. Peel Strength

One aforementioned brown oxide treated core was selected, and each of the two sides of the brown oxide treated core was stacked with one aforementioned RCC (100 μm). They were then laminated and cured under vacuum at a temperature of 220 °C and a pressure of 350 psi for 2 hours, followed by cooling. After the carrier copper foils on both sides were removed, the outer surface of the ultra-thin copper foil on each of the two sides was electroplated with 12 μm thick copper, followed by cutting to form a rectangular sample with a width of 24 mm and a length greater than 60 mm. The copper on the surface was etched, leaving only a rectangular copper foil with a width of 3.18 mm and a length greater than 60 mm. Measurement was conducted using a universal tensile testing machine at room temperature (about 25 °C) by reference to the method stated in IPC-TM-650 2.4.8. The force required to peel copper away from the surface of a resin layer was the peel strength (in lb/in). It should be noted that under the same circumstances, improving the peel strength of the ultra-thin copper foil is significantly more difficult than improving that of conventional copper foil. Every increase of 0.1 lb/in in the peel strength of the ultra-thin copper foil presents substantial technical challenges.

The following observations can be made by comprehensively referring to the property test results in Tables 1-2:

Upon comparison of Examples E6 to E15 and E1 to E5, it can be found that after an epoxy resin was further added into the resin composition (with the mass ratio of the epoxy resin to the allylphenolic compound being 1:1 to 1:7), the value of the in-plane resin flow length of the resulting article was greater, indicating superior flowability; in addition, the peel strength of the ultra-thin copper foil was further significantly improved (increased from 4.3 lb/in to more than 4.5 lb/in, with an increase of at least 0.2 lb/in).

Upon further parallel comparison of Examples E6 to E8 and E9, it can be found that after an epoxy resin was further added into the resin composition (with the mass ratio of the epoxy resin to the allylphenolic compound being 1:1 to 1:4 vs. 1:7), the articles obtained from Examples E6 to E8 were significantly improved at least in terms of resin agglomeration property (improved from −5 points to −4 points, with an improvement magnitude reaching 20%).

Upon comparison of Examples E1 to E15 and Comparative Examples C1 to C2, it can be found that relative to 100 parts by weight of the maleimide represented by Formula (1), when the amount of the allylphenolic compound fell outside of the range of 5 to 15 parts by weight, the resulting article was significantly deteriorated in at least three properties, namely, resin agglomeration, in-plane resin flow length, and resin filling property.

Upon comparison of Examples E1 to E15 and Comparative Examples C3 to C4, it can be found that relative to 100 parts by weight of the maleimide represented by Formula (1), when the amount of the (meth)acrylate monomer having a triazine ring and/or an oligomer thereof fell outside of the range of 10 to 30 parts by weight, the resulting article was significantly deteriorated in at least four properties, namely, resin agglomeration, in-plane resin flow length, resin filling property, and storage modulus decay rate.

Upon comparison of Examples E1 to E15 and Comparative Examples C5 to C8, it can be found that using several other types of maleimides different from the maleimide represented by Formula (1), the resulting article was significantly deteriorated in at least three properties, namely, resin agglomeration, in-plane resin flow length, and resin filling property.

Upon comparison of Examples E1 to E15 and Comparative Examples C9 to C10, it can be found that using other crosslinking agents other than the (meth)acrylate monomer having a triazine ring and/or an oligomer thereof, in combination with the maleimide represented by Formula (1) and allylphenol, the resulting article was significantly deteriorated in at least four properties, namely, resin agglomeration, in-plane resin flow length, storage modulus decay rate, and peel strength.

The foregoing descriptions are merely preferred embodiments of the present invention, and are not intended to limit the scope of the substantive technical content of the present invention. The substantive technical content of the present invention is broadly defined within the scope of the claims of the present application. Any other technical entities or methods accomplished by others that are identical to those defined in the scope of the claims of the present application or constitute an equivalent modification thereof shall be deemed as falling within the scope of the claims of the present application.

1. A resin composition, comprising:
(A) 100 parts by weight of maleimide represented by Formula (1),
(B) 10 to 30 parts by weight of a (meth)acrylate monomer having a triazine ring and/or an oligomer thereof, and
(C) 5 to 15 parts by weight of an allylphenolic compound, 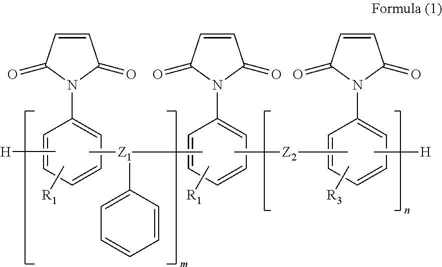
wherein in Formula (1), R₁ and R₃ each independently represent a C2-C5 alkyl group, R₂ represents a hydrogen atom or a C1-C5 alkyl group, m is a value of 1 to 10, n is a value of 1 to 10, and Z₁ and Z₂ each independently represent a C1-C5 alkylene group.

2. The resin composition of claim 1, wherein the (meth)acrylate monomer having the triazine ring and/or the oligomer thereof comprises any one or a combination of two or more of an acrylate monomer represented by Formula (A) and/or an oligomer thereof, and an acrylate monomer represented by Formula (B) and/or an oligomer thereof: 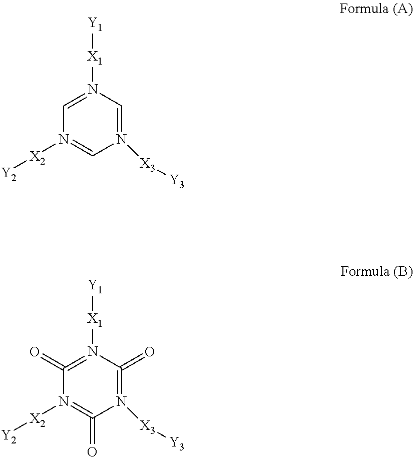
wherein in Formula (A) and Formula (B), X₁ to X₃ each independently represent a C1 to C5 alkylene group, and Y₁ to Y₃ each independently represent an acrylate group or a methacrylate group.

3. The resin composition of claim 1, wherein the allylphenolic compound comprises any one or a combination of two or more of allyl bisphenol A, allyl bisphenol F, allyl biphenol, and allyl fluorenol.

4. The resin composition of claim 1, wherein the allylphenolic compound comprises any one or a combination of two or more of allylphenol represented by Formula (3.1) to allylphenol represented by Formula (3.6):

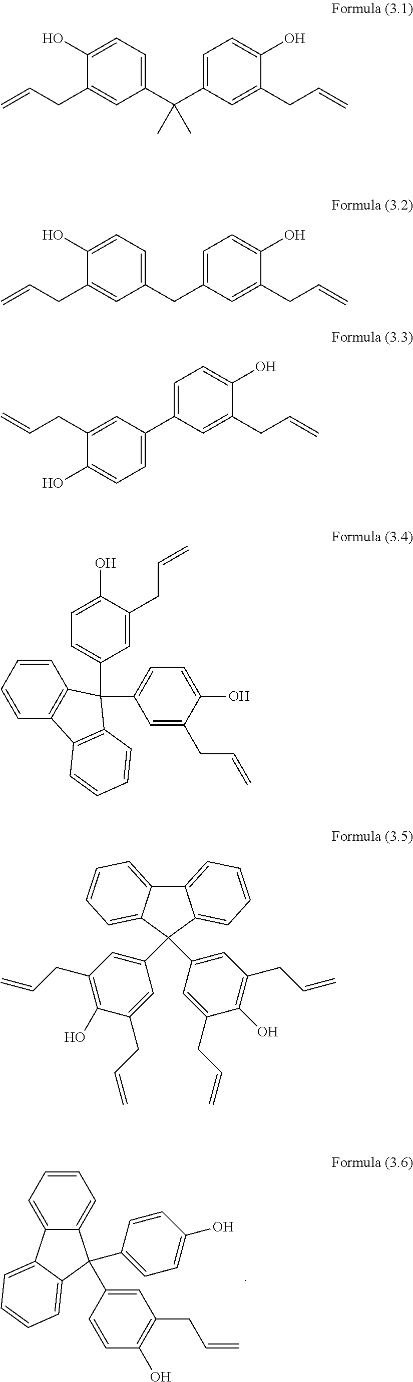

5. The resin composition of claim 1, wherein the resin composition further comprises an epoxy resin, with a mass ratio of the epoxy resin to the allylphenolic compound being 1:1 to 1:7.

6. The resin composition of claim 1, wherein the resin composition further comprises an epoxy resin, with a mass ratio of the epoxy resin to the allylphenolic compound being 1:1 to 1:4.

7. The resin composition of claim 5, wherein the epoxy resin comprises any one or a combination of two or more of bisphenol A epoxy resin, bisphenol F epoxy resin, bisphenol S epoxy resin, bisphenol AD epoxy resin, phenol novolac epoxy resin, bisphenol A novolac epoxy resin, bisphenol F novolac epoxy resin, bisphenol S novolac epoxy resin, bisphenol AD novolac epoxy resin, o-cresol novolac epoxy resin, phenol-aralkyl epoxy resin, naphthalene epoxy resin, biphenyl epoxy resin, dicyclopentadiene epoxy resin, benzofuran epoxy resin, isocyanate epoxy resin, and DOPO epoxy resin.

8. The resin composition of claim 1, wherein the resin composition further comprises any one or a combination of two or more of polyolefin, polyester resin, polyphenylene ether resin, silicone resin, benzoxazine resin, phenolic resin, amine curing agent, polyamide, polyimide, styrene maleic anhydride, cyanate ester, and maleimide triazine resin.

9. The resin composition of claim 1, wherein the resin composition further comprises any one or a combination of two or more of a flame retardant, a curing accelerator, a polymerization inhibitor, an inorganic filler, a solvent, a silane coupling agent, a surfactant, a coloring agent, and a toughening agent.

10. An article made from the resin composition of claim 1, wherein the article comprises a prepreg, a resin film, a metallic clad laminate or a printed circuit board.

11. The article of claim 10, wherein the article has a deduction for resin agglomeration of ≤5 points.

12. The article of claim 10, wherein the article has an in-plane resin flow length of 7.0 to 9.0 mm.

13. The article of claim 10, wherein the article has no voids and no dendritic patterns after a resin filling property test.

14. The article of claim 10, wherein the article has a resin flow decay rate of ≤4.0%.

15. The article of claim 10, wherein the article has a storage modulus decay rate as measured and calculated by reference to a method stated in IPC-TM-650 2.4.24.4 of ≤40%.

16. The article of claim 10, wherein the article has a peel strength as measured by reference to a method stated in IPC-TM-650 2.4.8 of ≥4.0 lb/in.
